(19) United States
(12) Patent Application Publication
(10) Pub. No.: US 2025/0383650 A1
(43) Pub. Date: Dec. 18, 2025

(54) SELF-CONTAINED, MODULAR SENSOR ARRAY FOR IN-SITU MONITORING AND DATA FUSION IN MANUFACTURING

(71) Applicant: VIRGINIA TECH INTELLECTUAL PROPERTIES, INC., Blacksburg, VA (US)

(72) Inventors: Christopher Williams, Blacksburg, VA (US); Tadeusz Kosmal, Blacksburg, VA (US); Sam Pratt, Blacksburg, VA (US)

(21) Appl. No.: 19/237,535

(22) Filed: Jun. 13, 2025

Related U.S. Application Data
(60) Provisional application No. 63/659,504, filed on Jun. 13, 2024.

(51) Int. Cl. G05B 19/418

(52) U.S. Cl. CPC G05B 19/4184; G05B 19/4183

(57) ABSTRACT

Various embodiments of in-situ geometric monitoring for manufacturing processes are described. In one example embodiment, a manufacturing workcell includes a plurality of in-situ sensors individually configured to capture discrete geometric signature data indicative of at least one layer of a printing part positioned in the manufacturing workcell during a manufacturing process. The manufacturing workcell further includes a computing device coupled to the plurality of in-situ sensors. The computing device includes a memory device to store computer-readable instructions thereon. The computing device further includes at least one processing device configured through execution of the computer-readable instructions to perform an in-situ evaluation of geometric error of the printing part at the manufacturing workcell during the manufacturing process based at least in part on the discrete geometric signature data.

### CROSS REFERENCE TO RELATED APPLICATIONS

This application claims the benefit of and priority to U.S. Provisional Application Ser. No. 63/659,504, filed Jun. 13, 2024, and titled “SELF-CONTAINED, MODULAR SENSOR ARRAY FOR IN-SITU MONITORING AND DATA FUSION IN MANUFACTURING,” the entire contents of which are hereby incorporated herein by reference.

### GOVERNMENT LICENSE RIGHTS

This invention was made with government support under grant number 450836 awarded by the Office of Naval Research (ONR). The government has certain rights in the invention.

### BACKGROUND

Additive Manufacturing's (AM) layer-wise construction is susceptible to stochastic process variation and fabrication errors. In-situ monitoring techniques have been proposed in literature to detect such errors by inspecting a localized deposition, a single layer, or a final part state. Conducting layer-wise evaluation of high-resolution scans presents significant sensing, geometric analysis, and data management issues that limit its applicability within a production environment.

### SUMMARY

The present disclosure is directed to in-situ geometric error monitoring, correction, and communication embodiments for manufacturing processes. The embodiments include and implement an in-situ geometric error monitoring, correction, and communication system and method. The embodiments include and implement a real-time or near real-time, in-situ geometric error monitoring, correction, and communication system and method that combines in-situ three-dimensional (3D) sensing of every layer of a part in fabrication and an in-situ geometric kernel that enables local and rapid geometric error evaluation.

Some embodiments include and implement a sensing array within a manufacturing workcell to collect data indicative of a part's geometry during its fabrication such as one or more of a 3D scan, thermal data, visual data, or acoustic data. The embodiments can use such collected sensor data to form a comprehensive part signature. The embodiments can then use the comprehensive part signature to perform a geometric comparison of the part against expected or simulated datums such as an intended or designed geometry for the part. The embodiments can also use results from a geometric comparison of a part to perform one or more operations in some examples such as informing autonomous manufacturing operations to correct an identified geometric error, adaptively plan toolpaths, or perform some other operation. In other examples, the embodiments can send results from a geometric comparison of a part to operators and users within augmented reality (AR) and virtual reality (VR) environments. In still other examples, the embodiments can render results from a geometric comparison of a part within AR and VR environments.

Aspects and advantages of embodiments of the present disclosure will be set forth in part in the following description or can be learned from the description or through practice of the embodiments. Other aspects and advantages of embodiments of the present disclosure will become better understood with reference to the appended claims and the accompanying drawings, all of which are incorporated in and constitute a part of this specification. The drawings illustrate example embodiments of the present disclosure and, together with the description, serve to explain the related concepts of the present disclosure.

According to one example embodiment, a manufacturing workcell includes a plurality of in-situ sensors individually configured to capture discrete geometric signature data indicative of at least one layer of a printing part positioned in the manufacturing workcell during a manufacturing process. The manufacturing workcell further includes a computing device coupled to the plurality of in-situ sensors. The computing device includes a memory device to store computer-readable instructions thereon. The computing device further includes at least one processing device configured through execution of the computer-readable instructions to perform an in-situ evaluation of geometric error of the printing part at the manufacturing workcell during the manufacturing process based at least in part on the discrete geometric signature data.

### BRIEF DESCRIPTION OF THE DRAWINGS

Many aspects of the present disclosure can be better understood with reference to the following figures. The components in the figures are not necessarily to scale, with emphasis instead being placed upon clearly illustrating the concepts of the disclosure. Moreover, repeated use of reference characters or numerals in the figures is intended to represent the same or analogous features, elements, or operations across different figures. Repeated description of such repeated reference characters or numerals is omitted for brevity.

FIG. 1 illustrates a block diagram of an example environment according to various aspects and embodiments of the present disclosure.

FIG. 2 illustrates a flow diagram of an example geometric monitoring process according to various aspects and embodiments of the present disclosure.

FIG. 3 illustrates an example sensor device according to various aspects and embodiments of the present disclosure.

FIGS. 4A and 4B illustrate images of an example scanner arrangement for global registration according to various aspects and embodiments of the present disclosure.

FIG. 5 illustrates an example global registration process according to various aspects and embodiments of the present disclosure.

FIG. 6A illustrates an example manufactured 3D marker according to various aspects and embodiments of the present disclosure.

FIG. 6B illustrates an example digital ground truth point cloud of the example manufactured 3D marker shown in FIG. 6A according to various aspects and embodiments of the present disclosure.

FIG. 7 illustrates an example alignment result of multiple 3D scanning systems according to various aspects and embodiments of the present disclosure.

FIG. 8 illustrates a simplified 2-dimensional example of an SDF-based evaluation of input scan points process according to various aspects and embodiments of the present disclosure.

FIG. 9A illustrates an example ASDF octree according to various aspects and embodiments of the present disclosure.

FIG. 9B illustrates an example SDF expression tree according to various aspects and embodiments of the present disclosure.

FIG. 10 illustrates an example GPU accelerated SDF point evaluation kernel according to various aspects and embodiments of the present disclosure.

### DETAILED DESCRIPTION

The layer-wise construction of Additive Manufacturing (AM) is susceptible to fabrication errors (e.g., delamination, porosity, sagging, etc.) during every step of the construction process. Post-process geometric evaluation techniques (e.g., three-dimensional (3D) scanning, X-ray Computer Tomography, etc.) are often used to document errors in material patterning, which allows users to quantify error and inform future processing changes that are tailored to amend previous build mistakes. This has led to coupling AM and automated geometric inspection for finishing and repair operations and in-situ monitoring for on-the-fly process changes.

Ideally, geometries could be built and inspected holistically within the manufacturing platform at every deposition layer to observe errors as they propagate during and after deposition. However, a key challenge in linking automated geometric inspection with AM is the extensive time required to collect geometric data of an as-built part and to analyze this data against the corresponding target geometry. Specifically, merging multiple scans to a common datum (e.g., with the aid of a human operator) and organizing scan points to be compared against the nearest faces of a target geometry (e.g., triangle mesh or boundary representation) is temporally intractable at every layer of an AM process. As such, pre/post process metrology of as-built geometries is common, as it forgoes observation of an AM process for a comprehensive documentation and evaluation of a final part state. Similarly, current in-situ inspection approaches limit the usage of data to (1) a single variable process control during construction (e.g., deposition size control), (2) a reduced dimensionality analysis, or (3) only information about a current layer.

Comprehensive analysis of printed geometries has traditionally been accomplished by post-process 3D scanning of geometries. One study used Structured Light Scanning (SLS) to 3D scan a damaged part's exterior. The damaged part's scan allowed a voxel-based identification of the necessary repair volume to inform future repair depositions. Another study adopted a similar approach by using SLS to inform post-process machining. With collected scan data, meshes were formed, and then compared against the as designed geometry. Another study used X-ray Computer Tomography (XCT) to query fully fabricated AM structures post process. Using the collected XCT point clouds, deviation maps using Hausdorff distance were constructed between points from the as-built and as-designed geometry, allowing identification of missing features. Despite the ability to capture a complete representation of a manufactured part state (e.g., in the form of 3D scan data), these studies only facilitate geometric inspection before or after a manufacturing process due to the large time associated with collecting and processing 3D scan data. In addition, the part must be transferred between scanning and manufacturing work cells, which often requires a tedious re-registration of the part into each machine's coordinate system. Furthermore, defects that arise during the deposition process, like the porosity noted by one study, cannot be detected with ex-situ measurements to (1) amend build errors or (2) scrap the part, which leads to non-performant parts and material waste. Catching such errors requires iterative metrological analysis at every print layer, which necessitates in-situ inspection.

For layer-wise geometric defect detection (i.e., in-situ inspection), computer-vision offers a fast mechanism to assess built geometries against a target geometry, albeit with two-dimensional data. One study used an extruder-mounted microscope to image as-built Material Extrusion (MEX) deposition profiles at the current layer using traditional image processing (e.g., edge detection). The signed distance between detected contours and a ground truth contour model derived from g-code was then used to convey error. Despite this layer-by-layer approach, the analysis was localized only to individual depositions, failing to capture a view of the entire layer or the entire part (whose geometry can change over the course of the build) and required rigorous data collection of every extruded road, which increased manufacturing time.

Another study improved this by observing the build volume and component with a single camera. Views of the entire print layer, infill, gross part dimensions, and contours from the most recent layer were analyzed against a sliced .STL. Despite viewing the build volume, only the current layer was evaluated and did not account for changes in the part geometry throughout the entire build process (e.g., warping, delamination). The researchers also note the addition of 30-60s per layer for image processing and analysis because of computationally expensive image processing. This limits the applicability of such approaches, with each still only employing a single camera. The use of a single camera adds occlusion of total part geometry, decreases the accuracy of depth measurements, and increases dependence on external lighting conditions for edge detection.

To alleviate the large data processing challenges associated with analyzing 3D scan data at every print layer, researchers have explored reducing the dimensionality of collected scan data into 2D images or contours, with the option to add grayscale and/or color channels as depth. Early deposition scanning was explored by one researcher who laser-line scanned single MEX beads and then compared the resultant scan points against a fitted curve datum to express error and inform current Z-height. In 2019, another study demonstrated conversion of top-down laser-line scans of MEX prints into 2D images. With 2D depth images, a different study subtracted the collected 2D image from an expected depth image created with the underlying as-designed geometry to detect under and/or overfill errors. This methodology was expanded upon by yet another researcher who applied image-based Machine Learning (ML) techniques to the collected 2D depth images for identifying geometric process shifts. One study similarly used several ML approaches to label under/over extruded areas, and modify future deposition accordingly. Another study extracted 2D point contours from collected SLS 3D scans and used a novel recurrence plot methodology to characterize defects of highly complex, metamaterial topologies.

All the aforementioned approaches only collect data from the top-most layer and convert 3D scan data into a 2D format. While reducing dimensionality yields faster computational analysis (e.g., one study reported less than 1 second), global (and transient) part 3D errors-like delamination—are visually occluded and hence, undetected. Most current AM in-situ geometric monitoring techniques limit their optical interrogation to top-down observation from a single fixed or traversing viewpoint. Since this approach leads to occlusions in elements of the part geometry, it favors 2D data analysis on the most recent printed layers, which fails to capture transient errors that occur on previously deposited layers (e.g., delamination and warping). Furthermore, the ML approaches noted above only express the likelihood that an error exists and not the numeric deviation of as-built structures compared to a target geometry. ML models are also dependent on training data and model hyperparameters, which limits their ability to be deployed into new manufacturing environments where error scale and resolution are variable.

Comprehensive layer-wise geometric error analysis throughout the build process requires in-situ 3D scanning of the part, and a computational ability that provides rapid comparative analysis of a printed part geometry against an intended or designed geometry for the part. To enable real-time or near real-time error analysis of 3D geometry at each layer, embodiments of the present disclosure include convergent innovation in both optical instrumentation and computational geometric analysis. Specifically, the embodiments include a suite of embedded 3D scanning systems, and a corresponding Adaptively Sampled Distance Function (ASDF) geometric framework that is able to rapidly quantify 3D errors at every print layer.

The notion of rapid 3D scanning and geometric evaluation is especially relevant to AM processes where a part is observable during fabrication and feed-forward process parameters do not guarantee dimensional control, such as Wire Arc Directed Energy Deposition (often referred to as wire arc AM, or WAAM). The lack of control over melt-pool distribution leads Wire Arc DED builds to have low resolution. Furthermore, the repetitive thermal input from deposition at each layer induces dimensional change and transience in layer state across an entire build process. This challenge makes Wire Arc DED susceptible to cracking, delamination, porosity, and residual stress deformation that are not visible from top-layer-only monitoring systems. Mitigating error mechanisms is dependent on part geometry, deposition path, material, etc., and formulating an optimal feed-forward manufacturing solution may not be feasible. Hence, creating a methodology to report 3D error for future feedback systems is critical. Some examples described herein validate the coupled metrology and geometric representation framework of the embodiments through a series of physical experiments. While the error analysis methodology of the embodiments is described within the context of Wire Arc DED in some examples, the overall system and method can be generalized to any AM, SM, or hybrid process.

Various embodiments of the present disclosure include a manufacturing sensing array (e.g., three-dimensional (3D) scanning, visual, and thermal sensing) with an onboard graphics processing unit (GPU) accelerated geometric kernel that can compare collected data against expected or simulated datums. The ability of the embodiments to host comparison on such a manufacturing sensor array deviates from traditional sensing capability where all raw collected data must be transferred to an external compute infrastructure. This onboard comparison ability allows manufacturing sensing arrays (or “sensing packs”) of the embodiments to scale and operate independently in-situ to a manufacturing process, while only conveying deviation data externally. The variety of sensors (e.g., including a projector in some examples) included in and implemented by the embodiments allows collected data to be fused together and prepared for human interaction in a virtual reality (VR) and/or augmented reality (AR) environment.

Embodiments include two key technologies: (1) a “scanning pack” hardware that can be placed within a manufacturing system and (2) a GPU-accelerated geometric kernel software that can be implemented to rapidly compare captured optical data such as a 3D scan of an actual built part against an as-designed model. The embodiments can perform in-situ evaluation of geometric error during a manufacturing process. Multiple sensing packs included in each embodiment can be placed within a manufacturing environment to collect a holistic geometric signature of a part. The embodiments can each implement an on-board accelerated geometric kernel to evaluate collected optical signature data of a part to inform (1) at least one of part quality or qualification and (2) future changes in the build process to amend errors. Embodiments can perform such evaluation at any point during a construction process (e.g., layer-by-layer for additive manufacturing (AM) or subtractive manufacturing (SM)), allowing errors to be identified and mitigated immediately. Embodiments can also generate visualizations of evaluated optical signature data of a part in augmented reality or virtual reality for human understanding (e.g. education, scientific discovery, operator safety etc.) of an existing manufacturing state. For instance, embodiments can generate visualizations of geometric error, thermal state, and other optically derived data indicative of a part.

The embodiments can perform layer-wise geometric evaluation during additive manufacturing and subtractive manufacturing. Embodiments can include any number of sensor packs that can be added to a manufacturing environment to document one or more states of a part during its fabrication. Data indicative of a part such as a 3D scan, thermal, visual, and acoustic data can be collected by one or more sensing arrays of each embodiment, allowing formation of a comprehensive part signature. Embodiments can use results from a geometric comparison of a part to inform autonomous manufacturing operations to correct geometric error, adaptively plan toolpaths, or perform some other operation. Embodiments can also send such results to operators and users within an AR or VR environment seeking information about the part.

Conducting layer-wise evaluation of high-resolution scans presents significant sensing, geometric analysis, and data management issues that limit its applicability within a production environment. To address these limitations, embodiments include a system and methodology to rapidly capture and characterize geometric error of a printing part using a digitally integrated Structured Light Scanning (SLS) system and Adaptively Sampled Distance Function (ASDF) method. In one embodiment, in-situ geometric deviation of printed structures can be analyzed within seconds over relatively large areas (e.g., 250 square centimeters (cm²)) at a high spatial resolution (e.g., 0.3 millimeters (mm)). The method of and implemented by the embodiments is agnostic to any AM process in which a full part is visible throughout a build (e.g., material extrusion, directed energy deposition, material jetting). The method was validated in one example by way of a layer-by-layer analysis of Wire-Arc Directed Energy Deposition (DED) AM.

The embodiments include and implement a real-time or near real-time, in-situ geometric error monitoring system and methodology that combines in-situ 3D scanning of every layer of a part in fabrication and an onboard graphics processing unit (GPU) accelerated geometric kernel that enables local and rapid geometric error evaluation. To accomplish this, the embodiments include multiple Structured Light Scanning (SLS) systems mounted in a manufacturing workcell to capture, correspond, and triangulate images to form a point cloud in a reference frame of each scanning pack. Using a stored global registration result for each scanner, the embodiments can transform point clouds to a Machine Coordinate System (MCS) to create an actionable representation of a scanned part. The embodiments can pass scan points to a preformed ASDF for evaluation. After coupling points with ASDF instructions, the embodiments can evaluate points in parallel as described in examples herein. Preprocessing tasks, like statistical outlier removal, can also be performed by the embodiments before evaluation in some cases to mitigate miscellaneous points created from reflection.

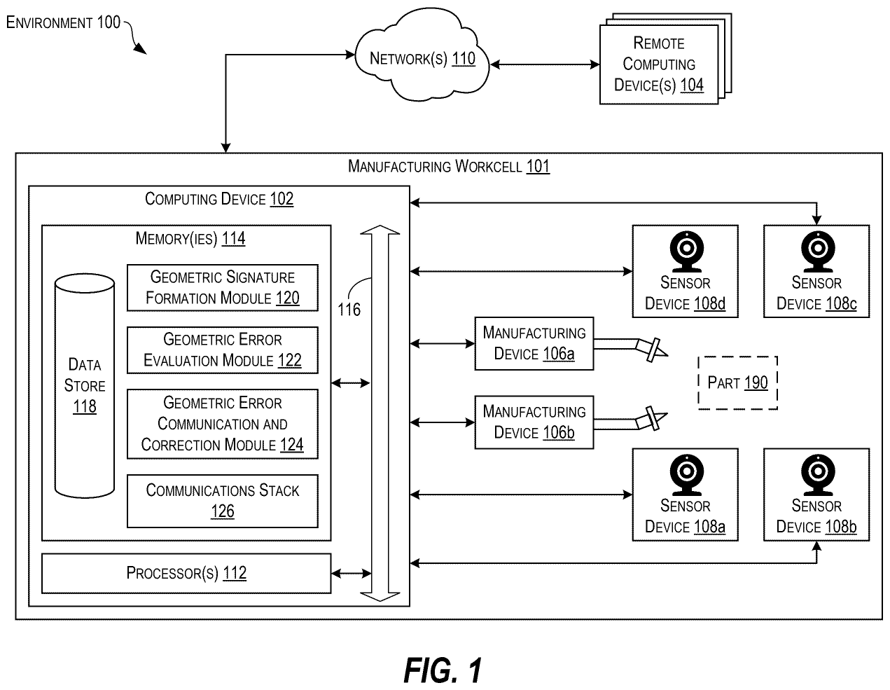

For context, FIG. 1 illustrates a block diagram of an example environment 100 according to various aspects and embodiments of the present disclosure. The environment 100 can be embodied and implemented as at least one of a manufacturing, sensing, computing, or data communication environment in which various in-situ geometric error evaluations of a part can be performed during fabrication of the part as described in examples herein. The environment 100 is illustrated as a representative example, and the in-situ geometric error evaluation concepts of embodiments described herein are not limited to use with any particular type of manufacturing, sensing, computing, or data communication environment.

The environment 100 in the example shown includes a manufacturing workcell 101. The manufacturing workcell 101 in this example includes a computing device 102, manufacturing devices 106a, 106b (or “manufacturing devices 106”), an in-situ sensor array of sensor devices 108a, 108b, 108c, 108d (or “sensor devices 108”), and a removable fabricated part 190 (or “part 190”). The part 190 is denoted in FIG. 1 with a dashed line to indicate it is removeable from the manufacturing workcell 101 and may be omitted or replaced by another removable fabricated part in other examples. The environment 100 in this example further includes one or more remote computing devices 104 (or “remote computing devices 104”) that can be coupled to the manufacturing workcell 101 by way of one or more networks 110 (or “networks 110”). For instance, each of the remote computing devices 104 can be coupled to the computing device 102 in the manufacturing workcell 101 by way of the networks 110.

The manufacturing workcell 101 can be embodied and implemented as a manufacturing, sensing, computing, and data communication system that can perform various real-time or near real-time, in-situ geometric monitoring operations as described in examples herein. For instance, the manufacturing workcell 101 can perform manufacturing operations (e.g., additive manufacturing, subtractive manufacturing), sensing or scanning operations (e.g., 3D scanning, image, video, audio, light, laser, thermal), computing operations (e.g., classical or legacy computing, supercomputing, quantum computing operations), and data communication operations (e.g., to inform augmented reality (AR) and virtual reality (VR) environments and users), among other operations. The manufacturing workcell 101 is illustrated as a representative example, and the real-time or near real-time, in-situ geometric monitoring embodiments and concepts described herein are not limited to use with any particular type of manufacturing, sensing, computing, or data communication system.

The manufacturing workcell 101 is illustrated as a representative example of a manufacturing, sensing, computing, and data communication system that can perform real-time or near real-time, in-situ geometric monitoring of a part being fabricated as described in examples herein. The manufacturing workcell 101 is not drawn to any particular scale or size in the drawings. The number, type, shape, size, proportion, and other characteristics of the manufacturing workcell 101 and any component thereof can vary as compared to that shown and described herein. For example, the manufacturing workcell 101 can accommodate a different number and type of manufacturing devices and sensor devices, and other variations are within the scope of the examples described herein. Additionally, one or more of the parts or components of the manufacturing workcell 101, as illustrated in the drawings and described herein, can be omitted in some cases (e.g., the part 190). The manufacturing workcell 101 can also include other parts or components that are not illustrated.

Each of the computing device 102, the manufacturing devices 106, and the sensor devices 108 can be at least partly or entirely positioned within, coupled to, and integrated into the manufacturing workcell 101 as illustrated in FIG. 1 in many cases. In some examples, the computing device 102 and one or more of the sensor devices 108 can be at least partly or entirely positioned within, coupled to, and integrated into a build region in the manufacturing workcell 101. For instance, the computing device 102 and each of the sensor devices 108 can be at least partly or entirely positioned within, coupled to, and integrated into a build region in the manufacturing workcell 101 where the part 190 can be fabricated during operation using at least one of the manufacturing devices 106. In other examples, the computing device 102 or a similar model or replica thereof can be at least partly or entirely positioned within, coupled to, and integrated into one or more of the sensor devices 108. For instance, the computing device 102 can be at least partly or entirely positioned within, coupled to, and integrated into the sensor device 108a and a similar model or replica of the computing device 102 can be at least partly or entirely positioned within, coupled to, and integrated into each of the sensor devices 108b, 108c, 108d. The computing device 102 is directly coupled (e.g., wired) to each of the manufacturing devices 106 and the sensor devices 108 in the example shown. In other examples, the computing device 102 may be indirectly coupled (e.g., wireless) to one or more of the manufacturing devices 106 or the sensor devices 108 by way of one or more networks that can be the same as or similar to the networks 110 described herein.

The computing device 102 in many examples can be embodied and implemented as an onboard computing device such as at least one of a client computing device, a general-purpose computer, a special-purpose computer, a graphics processing unit (GPU), a supercomputer chip or other System on a Chip (SoC), a laptop, a tablet, a smartphone, or other type of onboard computing device that can be configured and operable to perform various operations described herein. The computing device 102 in at least one example can be embodied and implemented as a GPU. In some cases, the computing device 102 can be embodied and implemented as a remote computing device such as at least one of a server computing device, a virtual machine, or another type of remote computing device that can be configured and operable to perform various operations described herein. For instance, the computing device 102 can be embodied and implemented in some cases as a remote computing device that is the same as or similar to one or more of the remote computing devices 104 described herein.

Any or all of the remote computing devices 104 in many examples can be individually embodied and implemented as at least one of a server computing device, a client computing device, a general-purpose computer, a special-purpose computer, a virtual machine, a supercomputer, a laptop, a tablet, a smartphone, or another type of computing device. Any or all of the remote computing devices 104 can be individually embodied as a server computer or related computing system providing computing capability in some cases. Any or all of the remote computing devices 104 can individually employ a plurality of computing devices arranged in one or more server banks, computer banks, or other arrangement in some examples. Such computing devices may be located in a single installation or may be distributed among many different geographical locations. For example, any or all of the remote computing devices 104 can individually include a plurality of computing devices implemented as a hosted computing resource, a grid computing resource, and/or any other distributed computing arrangement. In some cases, any or all of the remote computing devices 104 can each correspond to an elastic computing resource where the allotted capacity of processing, network, storage, or other computing-related resources may vary over time.

The manufacturing devices 106 can be embodied and implemented as various types of manufacturing or fabrication devices, equipment, tools, and corresponding materials used by such components to produce different parts. In some examples, one or both of the manufacturing devices 106 can be embodied and implemented as an additive manufacturing device such as a 3D printer or other device that can be used to at least partly fabricate a part by adding material to a unit of previously deposited material or material layers. In other examples, one or both of the manufacturing devices 106 can be embodied and implemented as a subtractive manufacturing device such as an etching system, a mill, a grinder, a polisher, or other device that can be used to at least partly fabricate a part by removing material from a unit of previously formed material or material layers. In still other examples, the manufacturing device 106a can be embodied and implemented as an additive manufacturing device and the manufacturing device 106b can be embodied and implemented as a subtractive manufacturing device.

The sensor devices 108 can each be embodied and implemented as various types of sensing or scanning devices in many examples. For instance, any or all of the sensor devices 108 can be embodied and implemented as at least one of a camera, a stereo camera, a digitally integrated structured light scanning (SLS) system, a stereo SLS, a 3D scanner, an optical scanner, a laser scanner, a thermal scanner, a microphone, or other sensing or scanning device. The sensor devices 108 can each be configured to capture its own unique or discrete sensor data such as unique or discrete geometric signature data indicative of at least one layer or region of the part 190 in the manufacturing workcell 101 during a manufacturing process (e.g., additive manufacturing, subtractive manufacturing). For instance, the sensor devices 108 can be positioned at and coupled to different locations in or about the manufacturing workcell 101 relative to one another to provide such unique or discrete geometric signature data, as it can be captured from different vantage points by respective sensor devices 108 at these different locations in or about the manufacturing workcell 101.

The networks 110 can include, for instance, the Internet, intranets, extranets, wide area networks (WANs), local area networks (LANs), wired networks, wireless networks (e.g., cellular, WiFi®), cable networks, satellite networks, other suitable networks, or any combinations thereof. The computing device 102 and the remote computing devices 104 can communicate data with one another over the networks 110 using any suitable systems interconnect models and/or protocols. Example interconnect models and protocols include hypertext transfer protocol (HTTP), simple object access protocol (SOAP), representational state transfer (REST), real-time transport protocol (RTP), real-time streaming protocol (RTSP), real-time messaging protocol (RTMP), user datagram protocol (UDP), internet protocol (IP), transmission control protocol (TCP), and/or other protocols for communicating data over the networks 110, without limitation. Although not illustrated, the networks 110 can also include connections to any number of other network hosts, such as website servers, file servers, networked computing resources, databases, data stores, or other network or computing architectures in some cases.

Among other operations, the computing device 102 (e.g., via the processor 112, the memory 114) can be configured to operate each of the sensor devices 108 in many cases to perform in-situ 3D sensing of every layer of the part 190 during its fabrication in the manufacturing workcell 101. For instance, the computing device 102 can operate each of the sensor devices 108 individually to capture unique or discrete 3D sensor data from different vantage points in or about the manufacturing workcell 101. For example, the computing device 102 can operate each of the sensor devices 108 individually to capture unique or discrete geometric signature data indicative of one or more layers or regions of the part 190 from different vantage points in or about the manufacturing workcell 101 during fabrication.

The computing device 102 can be further configured in many examples to generate a comprehensive part signature or comprehensive geometric signature data for the part 190 based at least in part on such unique or discrete geometric signature data captured by respective sensor devices 108 during fabrication. For instance, the computing device 102 can perform a data fusion process to generate comprehensive geometric signature data indicative of a subset of layers of the part 190 at some time during fabrication using unique or discrete geometric signature data indicative of such a subset of layers of the part 190 captured by respective sensor devices 108 at such a time during fabrication.

The computing device 102 can also be configured in many cases to provide real-time or near real-time, in-situ geometric error evaluation of such a comprehensive part signature or comprehensive geometric signature data at the manufacturing workcell 101 during fabrication of the part 190. For instance, the computing device 102 can implement an onboard GPU accelerated geometric kernel at the manufacturing workcell 101 to locally compare such comprehensive geometric signature data of the part 190 to a reference or as-designed model (e.g., a ground truth model) for the part 190 in real-time or near real-time during its fabrication. For example, the computing device 102 can implement an onboard GPU accelerated geometric kernel that includes and implements an adaptively sampled distance function (ASDF) described herein to locally compare such comprehensive geometric signature data against an as-designed model for the part 190 at the manufacturing workcell 101 and in real-time or near real-time during fabrication.

The computing device 102 can also be configured in many cases to perform one or more operations based at least in part on detecting a geometric error in the part 190 when comparing its comprehensive geometric signature data against a reference or as-designed model during fabrication. For instance, the computing device 102 can modify at least one of the part 190 or a manufacturing process applied to the part 190 based at least in part on one or more of its comprehensive geometric signature data or an identified geometric error. For example, the computing device 102 can be configured to operate one or both of the manufacturing devices 106 in some cases to directly modify one or more portions or layers of the part 190 to correct an identified geometric error. In another example, the computing device 102 can be configured to alter code or instructions of an automated or autonomous manufacturing process that can be implemented by one or both of the manufacturing devices 106 to fabricate the part 190. In other examples, the computing device 102 can provide (e.g., via the networks 110) at least one of comprehensive geometric signature data or an identified geometric error for the part 190 to any or all of the remote computing devices 104. In some cases, any or all of the remote computing devices 104 can modify at least one of the part 190 or a manufacturing process applied to the part 190 based at least in part on one or more of its comprehensive geometric signature data or an identified geometric error.

The computing device 102 can also format at least one of discrete comprehensive signature data, comprehensive geometric signature data, an identified geometric error, or an as-designed model corresponding to the part 190 for visual rendering in at least one of an augmented reality (AR) environment or a virtual reality (VR) environment in some cases. In still another example, the computing device 102 can render (e.g., via the networks 110) visualizations of at least one of discrete geometric signature data, comprehensive geometric signature data, an identified geometric error, or an as-designed model corresponding to the part 190 in at least one of an AR or VR environment.

To perform geometric error evaluation, correction, and communication operations described herein in connection with a part undergoing a manufacturing process (e.g., AM, SM) in a manufacturing workcell, the computing device 102 can include at least one processing and memory system. In the example depicted in FIG. 1, the computing device 102 includes at least one processor 112 and at least one memory 114, both of which are communicatively coupled, operatively coupled, or both, to a local interface 116. The memory 114 includes a data store 118, a geometric signature formation module 120, a geometric error evaluation module 122, a geometric error communication and correction module 124, and a communications stack 126 in the example shown. The computing device 102 can also include other components that are not illustrated in FIG. 1.

The processor 112 can be embodied as or include any processing device (e.g., a graphics processing unit (GPU), a processor core, a microprocessor, an application specific integrated circuit (ASIC), a field-programmable gate array (FPGA), a controller, a microcontroller, or a quantum processor) and can include one or multiple processors that can be operatively connected. In some examples, the processor 112 can include one or more complex instruction set computing (CISC) microprocessors, one or more reduced instruction set computing (RISC) microprocessors, one or more very long instruction word (VLIW) microprocessors, or one or more processors that are configured to implement other instruction sets. The processor 112 in at least one example can be embodied and implemented as a GPU.

The memory 114 can be embodied as one or more memory devices and can store data and software or executable-code components executable by the processor 112. For example, the memory 114 can store executable-code components associated with the geometric signature formation module 120, the geometric error evaluation module 122, the geometric error communication and correction module 124, and the communications stack 126 for execution by the processor 112. The memory 114 can also store data such as the data described below that can be stored in the data store 118, among other data. In one example, the memory 114 can store at least one of discrete geometric signature data, comprehensive geometric signature data, identified geometric errors, reference models, as-designed models, or ground truth models corresponding to parts such as the part 190. In another example, the memory 114 can store one or more databases (e.g., lists, tables, logs, records, indexes) including defined actions or operations that are to be performed based at least in part on detecting a geometric error in or on parts being fabricated in the manufacturing workcell 101 such as the part 190.

The memory 114 can store other executable-code components for execution by the processor 112. For example, an operating system can be stored in the memory 114 for execution by the processor 112. Where any component discussed herein is implemented in the form of software, any one of a number of programming languages can be employed such as, for example, C, C++, C#, Objective C, JAVA®, JAVASCRIPT®, Perl, PHP, VISUAL BASIC®, PYTHON®, RUBY, FLASH®, or other programming languages.

As discussed above, the memory 114 can store software for execution by the processor 112. In this respect, the terms “executable” or “for execution” refer to software forms that can ultimately be run or executed by the processor 112, whether in source, object, machine, or other form. Examples of executable programs include, for instance, a compiled program that can be translated into a machine code format and loaded into a random access portion of the memory 114 and executed by the processor 112, source code that can be expressed in an object code format and loaded into a random access portion of the memory 114 and executed by the processor 112, source code that can be interpreted by another executable program to generate instructions in a random access portion of the memory 114 and executed by the processor 112, or other executable programs or code.

The local interface 116 can be embodied as a data bus with an accompanying address/control bus or other addressing, control, and/or command lines. In part, the local interface 116 can be embodied as, for instance, an on-board diagnostics (OBD) bus, a controller area network (CAN) bus, a local interconnect network (LIN) bus, a media oriented systems transport (MOST) bus, ethernet, or another network interface.

The data store 118 can include data for the computing device 102 such as, for instance, one or more unique identifiers for the computing device 102, digital certificates, encryption keys, session keys and session parameters for communications, and other data for reference and processing. The data store 118 can also store computer-readable instructions for execution by the computing device 102 via the processor 112, including instructions for the geometric signature formation module 120, the geometric error evaluation module 122, the geometric error communication and correction module 124, and the communications stack 126.

In some cases, the data store 118 can also store any or all of the aforementioned data, information, or databases that can be stored in the memory 114. For example, the data store 118 can store at least one of discrete geometric signature data, comprehensive geometric signature data, identified geometric errors, reference models, as-designed models, or ground truth models corresponding to parts such as the part 190. In another example, the data store 118 can store databases (e.g., lists, tables, logs, records, indexes) including defined actions or operations that are to be performed based at least in part on detecting a geometric error in or on parts being fabricated in the manufacturing workcell 101 such as the part 190.

The geometric signature formation module 120 can be embodied as one or more software applications or services executing on the computing device 102. The geometric signature formation module 120 can be executed by the processor 112 to generate a comprehensive part signature or comprehensive geometric signature data indicative of one or more layers or regions of the part 190 at a certain time during fabrication. For instance, to generate such a comprehensive part signature or comprehensive geometric signature data, the geometric signature formation module 120 can perform a data fusion process using discrete geometric signature data indicative of the one or more layers or regions of the part 190 captured by respective sensor devices 108 at such a time during fabrication. To implement such a data fusion process in many examples, the geometric signature formation module 120 can perform a global registration process described in examples herein. For instance, the geometric signature formation module 120 can perform a global registration process to determine a homogenous transformation between reference frames of each of the sensor devices 108 and a reference frame of a machine coordinate system (MCS) corresponding to at least one of the environment 100, the manufacturing workcell 101, a build region in the manufacturing workcell 101 where the part 190 can be fabricated, or another manufacturing system in which the part 190 can be fabricated.

To complete a global registration process described in examples herein, the geometric signature formation module 120 can operate (e.g., via the processor 112) each of the sensor devices 108 independently to separately capture unique or discrete 3D scans of a physical 3D marker aligned to an MCS corresponding to at least one of the manufacturing workcell 101 or a build region thereof. The geometric signature formation module 120 can then obtain point clouds generated in reference frames of each of the sensor devices 108 for such 3D scans of the physical 3D marker aligned to such an MCS. The geometric signature formation module 120 can then transform the reference frames of each of the sensor devices 108 to the reference frame of such an MCS by fitting the point clouds of the sensor devices 108 to a ground truth marker point cloud aligned with the MCS. For instance, the geometric signature formation module 120 can transform the reference frames of each of the sensor devices 108 to the reference frame of such an MCS by fitting each of their point clouds to a ground truth marker point cloud that is aligned with the MCS and has been previously generated based at least in part on a reference or as-designed model corresponding to the part 190 and the physical 3D marker. For example, such a ground truth marker point cloud can be generated from and correspond to a reference or as-designed model for the part 190 and the physical 3D marker. In some cases, the geometric signature formation module 120 can implement a random sample consensus process for global registration of the point clouds of each of the sensor devices 108 to a ground truth marker point cloud aligned with an MCS. In some examples, the geometric signature formation module 120 can implement a point-to-plane iterative-closest-point process for final registration of the point clouds of each of the sensor devices 108 to a ground truth marker point cloud aligned with an MCS.

The geometric error evaluation module 122 can be embodied as one or more software applications or services executing on the computing device 102. The geometric error evaluation module 122 can be executed by the processor 112 to provide real-time or near real-time, in-situ geometric error evaluation of a comprehensive part signature or comprehensive geometric signature data indicative of at least one layer or region of the part 190 at the manufacturing workcell 101 during fabrication of the part 190 as described in examples herein. For instance, the geometric error evaluation module 122 can be executed by the processor 112 to implement an onboard GPU accelerated geometric kernel at the manufacturing workcell 101 to locally compare such comprehensive geometric signature data of the part 190 to a reference or as-designed model (e.g., a ground truth model) for the part 190 in real-time or near real-time during its fabrication. For example, the geometric error evaluation module 122 can be executed by the processor 112 to implement an onboard GPU accelerated geometric kernel that includes and implements an adaptively sampled distance function (ASDF) described herein to locally compare such comprehensive geometric signature data against an as-designed model for the part 190 at the manufacturing workcell 101 and in real-time or near real-time during fabrication.

The geometric error communication and correction module 124 can be embodied as one or more software applications or services executing on the computing device 102. The geometric error communication and correction module 124 can be executed by the processor 112 to perform or facilitate performance of one or more operations based at least in part on detection of a geometric error in the part 190 by the geometric error evaluation module 122 during fabrication as described in examples herein. For instance, the geometric error communication and correction module 124 can be executed by the processor 112 to modify at least one of the part 190 or a manufacturing process applied to the part 190 based at least in part on one or more of its comprehensive geometric signature data or an identified geometric error. For example, the geometric error communication and correction module 124 can be executed by the processor 112 to operate one or both of the manufacturing devices 106 in some cases to directly modify one or more portions or layers of the part 190 to correct an identified geometric error. In another example, the geometric error communication and correction module 124 can be executed by the processor 112 to alter code or instructions of an automated or autonomous manufacturing process that can be implemented by one or both of the manufacturing devices 106 to fabricate the part 190. In other examples, the geometric error communication and correction module 124 can be executed by the processor 112 to provide (e.g., via the networks 110) at least one of comprehensive geometric signature data or an identified geometric error for the part 190 to any or all of the remote computing devices 104. In some cases, the geometric error communication and correction module 124 can be executed by the processor 112 to format at least one of discrete comprehensive signature data, comprehensive geometric signature data, an identified geometric error, or an as-designed model corresponding to the part 190 for visual rendering in at least one of an AR or VR environment. In still another example, the geometric error communication and correction module 124 can be executed by the processor 112 to render (e.g., via the networks 110) visualizations of at least one of discrete geometric signature data, comprehensive geometric signature data, an identified geometric error, or an as-designed model corresponding to the part 190 in at least one of an AR or VR environment.

The communications stack 126 can include software and hardware layers to implement data communications such as, for instance, Bluetooth®, Bluetooth® Low Energy (BLE), WiFi®, cellular data communications interfaces, or a combination thereof. Thus, the communications stack 126 can be relied upon by the computing device 102 to establish cellular, Bluetooth®, WiFi®, and other communications channels with the networks 110 and with at least one of the remote computing devices 104 or other computing devices.

The communications stack 126 can include the software and hardware to implement Bluetooth®, BLE, and related networking interfaces, which provide for a variety of different network configurations and flexible networking protocols for short-range, low-power wireless communications. The communications stack 126 can also include the software and hardware to implement WiFi® communication, and cellular communication, which also offers a variety of different network configurations and flexible networking protocols for mid-range, long-range, wireless, and cellular communications. The communications stack 126 can also incorporate the software and hardware to implement other communications interfaces, such as X10®, ZigBee®, Z-Wave®, and others.

The communications stack 126 can be configured to communicate various data or information amongst the computing device 102 and the remote computing devices 104. Examples of such data or information can include, but is not limited to, discrete geometric signature data, comprehensive geometric signature data, identified geometric errors, reference models, as-designed models, and ground truth models, as well as databases (e.g., lists, tables, logs, records, indexes) including defined actions or operations that are to be performed based at least in part on detecting a geometric error in or on parts being fabricated in the manufacturing workcell 101 such as the part 190, or other data or information.

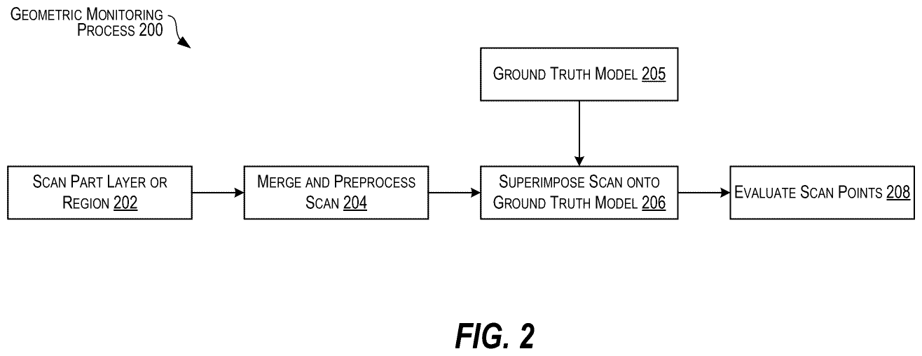

FIG. 2 illustrates a flow diagram of an example geometric monitoring process 200 (or “process 200”) according to various aspects and embodiments of the present disclosure. It is understood that the flowchart of FIG. 2 provides merely an example of the many different types of functional arrangements that may be employed to implement the operation of the portion of at least one of the geometric signature formation module 120, the geometric error evaluation module 122, the geometric error communication and correction module 124, or the communications stack 126 as described herein. As an alternative, the flowchart of FIG. 2 may be viewed as depicting an example of elements of a method implemented in the environment 100 (FIG. 1) according to one or more embodiments. In one example, the process 200 can be implemented by the computing device 102 (e.g., via any or all of the geometric signature formation module 120, the geometric error evaluation module 122, and the geometric error communication and correction module 124) using one or more of the remote computing devices 104, the manufacturing devices 106, or the sensor devices 108 as described herein with reference to FIG. 1. The process 200 is an example overall workflow that can be implemented by the embodiments from 3D scan to geometric error evaluation as described herein and illustrated in the figures. The process 200 is an example geometric monitoring process according to various aspects and embodiments of the present disclosure.

At 202, the process 200 includes scanning at least one layer or region of part such as the part 190 being fabricated in a manufacturing workcell such as the manufacturing workcell 101. For instance, the computing device 102 can operate (e.g., via the processor 112 and the geometric signature formation module 120) the sensor devices 108 as described above with reference to FIG. 1 to separately capture discrete 3D geometric signature data indicative of at least one layer or region of the part 190 from different vantage points in or about the manufacturing workcell 101.

At 204, the process 200 further includes merging and preprocessing scan data captured at 202. For instance, the computing device 102 can perform (e.g., via the processor 112 and the geometric signature formation module 120) a data fusion process to merge discrete 3D geometric signature data captured at 202 and generate comprehensive 3D geometric signature data indicative of at least one layer or region of the part 190. For example, the computing device 102 can perform such a data fusion process at the manufacturing workcell 101 during fabrication of the part 190.

At 206, the process 200 further includes superimposing comprehensive scan data merged at 204 onto a ground truth or as-designed model corresponding to a part being fabricated such as the part 190. The process 200 at 208 also includes evaluating scan points in superimposed scan and ground truth data generated at 206 to determine any geometric error in the part 190.

The computing device 102 in many examples can superimpose (e.g., via the processor 112 and the geometric error evaluation module 122) comprehensive 3D geometric signature data generated at 204 onto a ground truth or as-designed model corresponding to and representative of the part 190 and further perform a comparison of scan points against points in such a model as described herein with reference to FIG. 1. For example, the computing device 102 can implement (e.g., via the processor 112 and the geometric error evaluation module 122) an onboard GPU accelerated geometric kernel at the manufacturing workcell 101 to locally compare such comprehensive 3D geometric signature data of the part 190 to a ground truth or as-designed model for the part 190 in real-time or near real-time during its fabrication. For example, the computing device 102 can implement an onboard GPU accelerated geometric kernel that includes and implements an adaptively sampled distance function (ASDF) described herein to locally compare such comprehensive 3D geometric signature data against a ground truth or as-designed model for the part 190 at the manufacturing workcell 101 and in real-time or near real-time during fabrication.

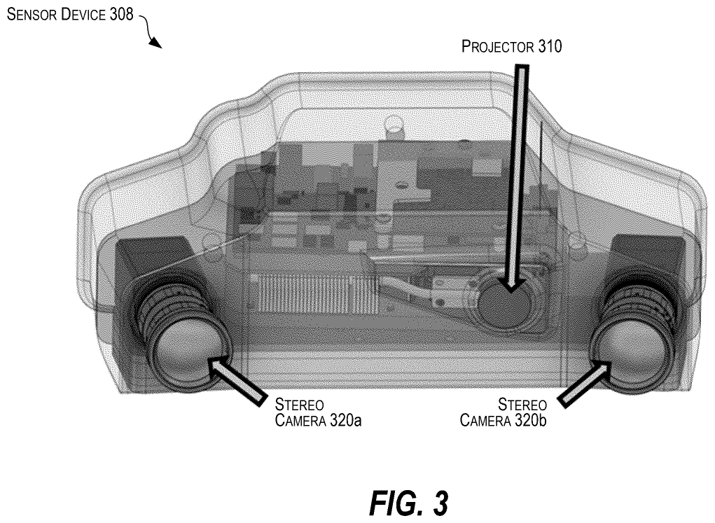

FIG. 3 illustrates an example sensor device 308 according to various aspects and embodiments of the present disclosure. The sensor device 308 can be embodied and implemented in many examples as an in-situ stereo structured light scanning (SLS) system. In many examples, the sensor device 308 can be used to at least partly embody and implement of any or all of the sensor devices 108 described herein and illustrated in the figures. For instance, the sensor device 308 can be one example embodiment of any or all of the sensor devices 108 described herein and illustrated in the figures.

Referring among FIGS. 1-3, the sensor device 308 can be integrated into the manufacturing workcell 101 as any of the sensor devices 108 in many examples. The sensor device 308 can be embodied as a stereo SLS system that can quickly capture high resolution (e.g., <1 mm) 3D scans across a large build area from a fixed position such as within the manufacturing workcell 101 in some cases. The sensor device 308 includes a projector 310 that can display a set of pattern images sequentially captured by a pair of cameras 320a, 320b in many examples. The projected patterns can be “decoded” to inform which pixels in each camera's frame represent the same point in global space. With corresponding pairs of pixels, depth can be triangulated to form a point cloud. The sensor device 308 can be embodied in some examples as an in-situ Gray Code Stereo SLS system positioned within the manufacturing workcell 101 to provide real-time access to depth data during a manufacturing process of the part 190 as described in examples herein.

Leveraging in-situ AM SLS optical considerations, the sensor device 308 embodied and implemented as an in-situ stereo SLS system includes two stereo cameras 320a, 320b and a projector 310 in the example shown. Operating at a working distance of 700 mm in one example, the sensor device 308 has a 0.75 meter (m)×0.5 m field of view, and a 260 micrometer (μm) resolution. The sensor device 308 can collect approximately 300,000 points per scan in some cases. This resolution allows for capture of visible surface defects within systems such as a Wire Arc DED system and can be readily adapted in various embodiments to specific process needs by reducing working distance and increasing camera sensor size and focal length.

The Gray Code image encoding method can be relied upon by the embodiments (e.g., the computing device 102 and any of the sensor devices 108) for its simplicity, and computationally inexpensive decoding time. While variable lighting conditions can affect the performance of the Gray Code method, some manufacturing systems such as instrumented Wire Arc DED manufacturing systems are already enclosed for safety, which allows for consistent, controlled lighting. Combined with a stereo SLS approach, the scanning system included in various embodiments (e.g., the computing device 102 and any of the sensor devices 108) is capable of accurately recovering wide-view shapes with less occlusion compared to other systems such as single camera-projector SLS systems, and the resolution is comparable to high-end commercial 3D scanners.

To enable layer-wise scanning in many examples, a Graphical Processing Unit (GPU) accelerated decoding approach can be implemented by the computing device 102 (e.g., via, the processor 112, the sensor devices 108, the geometric signature formation module 120, the geometric error evaluation module 122) to complete thresholding and gray code bit identification in parallel. The resulting decoding process implemented by the embodiments can be at least five times faster than serial computation in some cases and completed in under one second for such a GPU accelerated decoding configuration, thus limiting scans' impact on manufacturing time. Despite this acquisition speed, the computing device 102 can implement continuous SLS encoding methods such as three-step phase shifting in one example as an improvement for higher spatial resolution scans.

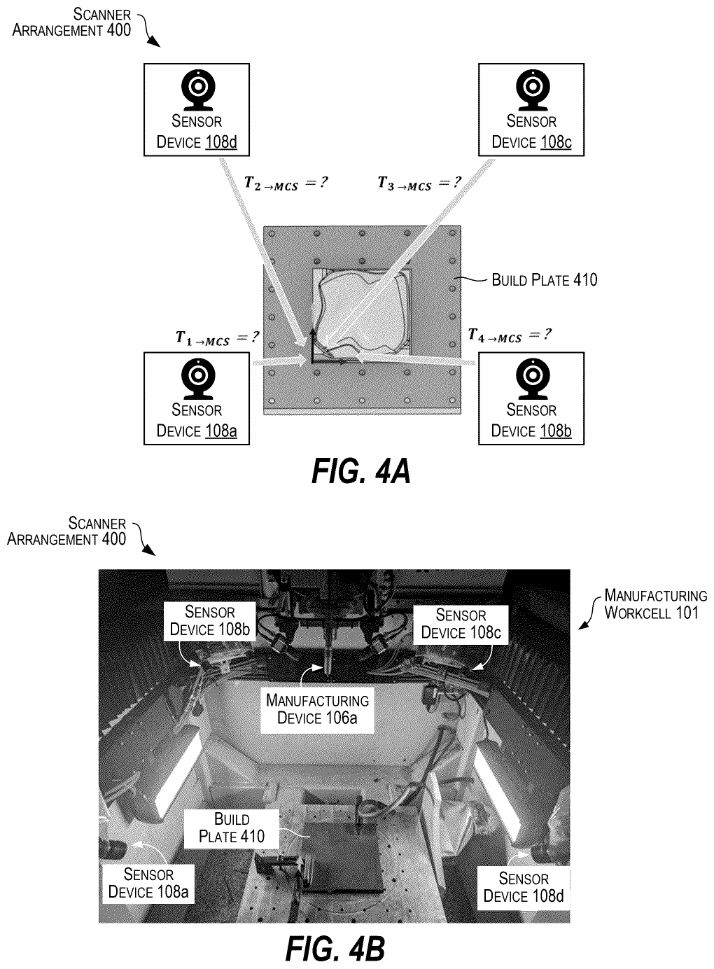

In many cases, 3D scans collected from each of the sensor devices 108 or the sensor device 308 are initially in each scanner's reference frame and can be transformed to an MCS for future process analysis and action as described in examples herein. This process, known as global registration or extrinsic calibration and shown in FIGS. 4A and 4B usually requires human intervention and is time intensive. FIGS. 4A and 4B illustrate images of an example scanner arrangement 400 for global registration according to various aspects and embodiments of the present disclosure. The scanner arrangement 400 illustrated in FIGS. 4A and 4B includes the sensor devices 108 arranged in the manufacturing workcell 101, which is embodied in this example as a 610 mm³ Wire Arc DED workspace (FIG. 4B). The sensor devices 108 are positioned isometrically to a build plate 410 at approximately 650 mm in this example. However, the computing device 102 can pre-register the sensor devices 108 to an MCS by fitting a collected scan of a physical 3D marker to a coordinate aligned ground truth marker point cloud in some cases.

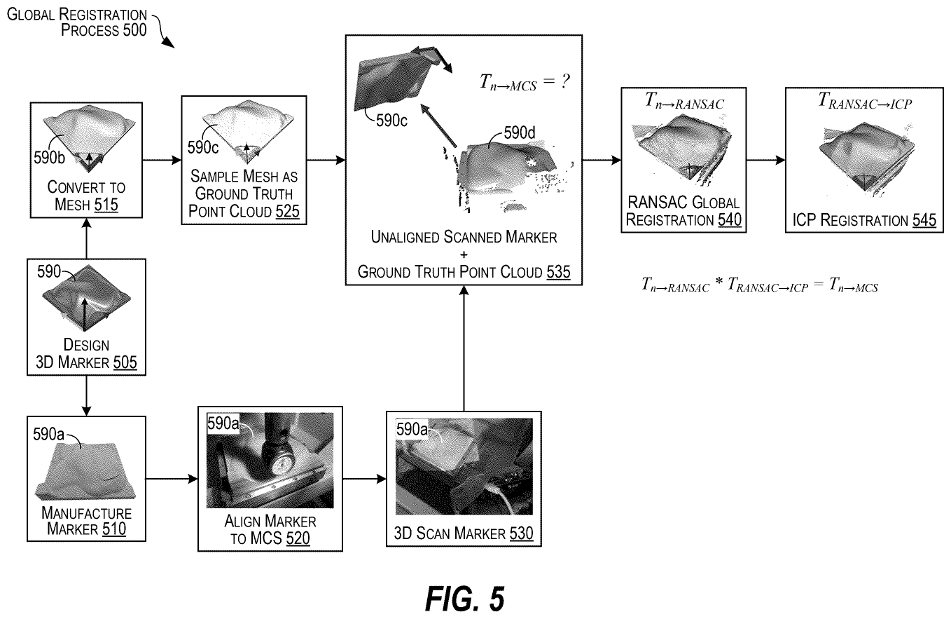

FIG. 5 illustrates a flow diagram of an example global registration process 500 (or “process 500”) according to various aspects and embodiments of the present disclosure. It is understood that the flowchart of FIG. 5 provides merely an example of the many different types of functional arrangements that may be employed to implement the operation of the portion of at least one of the geometric signature formation module 120, the geometric error evaluation module 122, the geometric error communication and correction module 124, or the communications stack 126 as described herein. As an alternative, the flowchart of FIG. 5 may be viewed as depicting an example of elements of a method implemented in the environment 100 (FIG. 1) according to one or more embodiments. In one example, the process 500 can be implemented by the computing device 102 (e.g., via any or all of the geometric signature formation module 120, the geometric error evaluation module 122, and the geometric error communication and correction module 124) using one or more of the remote computing devices 104, the manufacturing devices 106, or the sensor devices 108 as described herein with reference to FIG. 1.

The process 500 is an example global registration process that can be implemented by the computing device 102 (e.g., via the processor 112 and the geometric signature formation module 120) as described in examples herein to find a homogenous transformation between a scanner and an MCS such as between individual sensor devices 108 and an MCS corresponding to the manufacturing workcell 101 or a build region thereof (e.g., the build plate 410). The entire registration pipeline can be completed by the computing device 102 using Open3D in some examples. One study uses a similar approach, but instead uses fiducials mounted on a work specimen for fitting and coordinate system alignment. The approach implemented by the computing device 102 herein does not require the use of fiducials since the sensor devices 108 are located within the manufacturing platform (e.g., the manufacturing workcell 101), where one or more toolheads (e.g., the manufacturing devices 106) are referenced to the same coordinate system. This removes the need to transfer and localize a specimen (e.g., the part 190) between separate MCSs. Furthermore, the points collected by the computing device 102 from SLS optical pixel correspondence in many examples are analogous to identifying pixels occupied by a fiducial marker, but with a much higher number of data points, which reduces signal to noise ratio and improves coordinate system fitting.

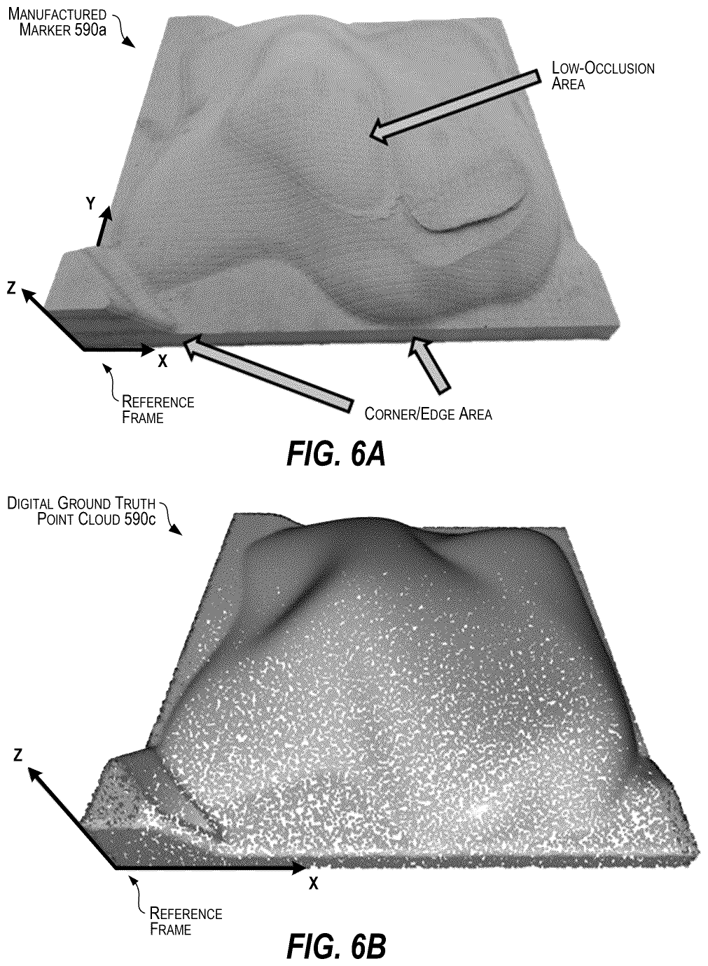

At 505 of the process 500, the computing device 102 can generate a design or as-designed 3D marker 590 to include rectangular corner features in addition to a low-profile organic body. At 510 of the process 500, the computing device 102 can further fabricate or facilitate fabrication of a physical or manufactured 3D marker 590a, also seen in FIG. 6A. FIG. 6A illustrates an example manufactured 3D marker 590a according to various aspects and embodiments of the present disclosure. During fitting, the low-profile organic section of the manufactured 3D marker 590a provides a large scanning surface with minimal occlusion and the corners provide discrete planes to fit to, mitigating scaling and alignment effects.

At 515 of the process 500, the computing device 102 can convert the design 3D marker 590 to a mesh 3D marker 590b. At 525 of the process 500, the computing device 102 can sample the mesh 3D marker 590b or the manufactured 3D marker 590a in some cases to create a digital ground truth point cloud 590c, also seen in FIG. 6B. For instance, the computing device 102 can sample points on the surfaces of a fiducial such as the manufactured 3D marker 590a or the mesh 3D marker 590b. FIG. 6B illustrates an example digital ground truth point cloud 590c of the example manufactured 3D marker 590a shown in FIG. 6A according to various aspects and embodiments of the present disclosure. The computing device 102 can position the reference frame of the digital ground truth point cloud 590c at the base of the largest corner feature in many examples. The manufactured 3D marker 590a illustrated in FIG. 6A is a physical version of a 3D fiducial marker that can be fabricated from MDF in one example by CNC machining with a precision beneath the scanner's resolution.

At 520 of the process 500, the computing device 102 can align or facilitate alignment of the flat surfaces and corner geometry of the manufactured 3D marker 590a to a physical MCS (e.g., an MCS corresponding to the manufacturing workcell 101) with the use of a dial indicator in some cases. Once aligned, at 530 of the process 500 the computing device 102 can operate each of the sensor devices 108 to individually scan the manufactured 3D marker 590a and produce a point cloud 590d in each device's reference frame. At 535 of the process 500, the computing device 102 can register each device's collected point cloud 590d to a ground truth marker point cloud (e.g., the ground truth point cloud 590c) already existing at such an MCS in a two-step process. For instance, at 540 of the process 500 the computing device 102 can use Random Sample Consensus (RANSAC) for global registration, and at 545 of the process 500 the computing device 102 can use a point-to-plane Iterative-Closest-Point (ICP) final registration as shown in FIG. 5. The final ICP registration to the design 3D marker 590 can have an inlier RMSE of <0.85 mm in various examples.

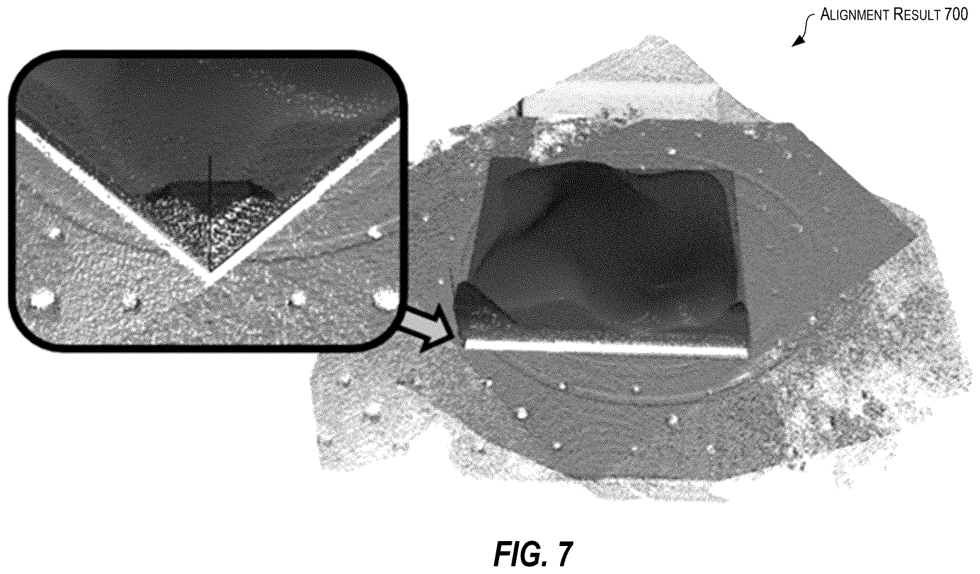

A final transformation gathered from the global registration pipeline and process 500 shown in FIG. 5 can be saved (e.g., in the memory 114, the data store 118) and used by the computing device 102 (e.g., via the processor 112, the geometric signature formation module 120, the geometric error evaluation module 122, the geometric error communication and correction module 124) to transform all subsequent 3D scans to the MCS during subsequent additive or subtractive manufacturing within a corresponding build volume. Since some embodiments of the manufacturing workcell 101 include scanners such as the sensor devices 108 rigidly mounted inside an AM system frame, and manufacturing operations are completed in reference to the MCS, the computing device 102 in these embodiments only needs to complete the global registration process 500 once. By implementing the global registration process 500 shown in FIG. 5 the computing device 102 can align any type of 3D scanning system placed within a manufacturing environment for comprehensive, in-situ layer-wise scan collection, as seen in FIG. 7 in one example.

FIG. 7 illustrates an example alignment result 700 of multiple 3D scanning systems according to various aspects and embodiments of the present disclosure. The alignment result 700 can be an example embodiment of the aforementioned comprehensive 3D geometric signature data that can be generated by the computing device 102 (e.g., via the geometric signature formation module 120) as described herein with reference to FIG. 1. The computing device 102 can obtain the example fitting result 700 shown in FIG. 7 by implementing the RANSAC+ICP pipeline and process 500 shown in FIG. 5. In the example shown in FIG. 7, the computing device 102 can overlay the registration result of 4 scanners such as the sensor devices 108 onto a common MCS.

The computing device 102 can position a fitted coordinate frame exactly at a marker's corner as shown in FIG. 7 in some cases. The fitting result of the camera's reference frame to the MCS is valid at every deposition layer in many examples, thus allowing the computing device 102 to complete layer-wise scan analysis as described herein with reference to FIG. 1. This step negates any future point cloud registration tasks, preparing collected points for immediate metrological analysis.

To perform near real-time comparison of large amounts of data produced from in-situ, layer-wise 3D scanning and rapidly compare an as-built geometry against a desired 3D geometry in some examples, the computing device 102 can leverage a known geometric framework based on Signed Distance Functions (SDFs), that could serve as a singular representation throughout the digital fabrication thread. SDFs are an implicit geometric representation that maps R³ data (X, Y, Z) to signed distance from a zero isosurface. Because an SDF maintains ∥∇f (X, Y, Z) ∥=1 for all space (e.g., Eikonal Equation), Euclidean distance is returned from the SDF. This has led to widespread use in Simultaneous Localization and Mapping (SLAM), computer graphics, and tool pathing, because the returned distance is relevant to a real-world operating environment.

However, these prior approaches solely use SDFs to extract the zero level-set surface, reformulate surfaces, or evaluate a single state (e.g., robot position) within an environment for use in planning. In contrast to these conventional use-cases, the computing device 102 can use SDFs as a datum for in-situ metrological analysis in many examples. For instance, the computing device 102 can use the SDF to represent the ideal designed geometry (e.g., a desired geometry). The computing device 102 can input collected scan points into an implicit SDF representation to gather a quantitative measurement of a physical distance to an ideal geometry. Because the computing device 102 can use scan points provided by the sensor devices 108, which are registered to the MCS, these measurements of physical distance represent the actual deviation from surface of the ideal part geometry in many cases. Furthermore, this approach can be implemented by the computing device 102 in many examples as a meshless approach that sidesteps the need to search for the nearest face and/or edge of a target geometry and it eliminates the need to preprocess scan points into an organized structure, thereby decreasing the time to evaluation.

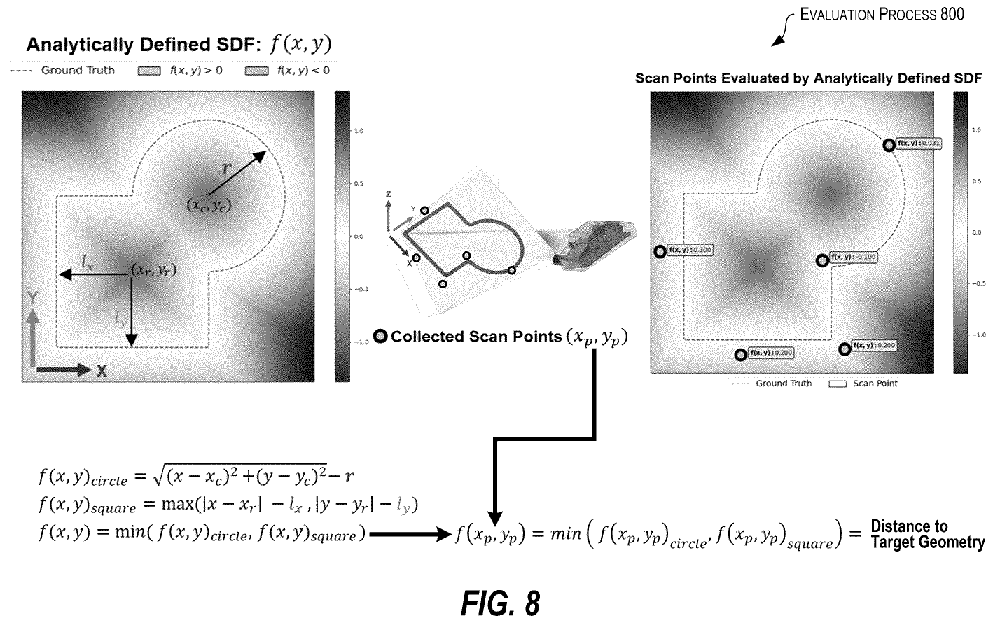

FIG. 8 illustrates a simplified 2-dimensional example of an SDF-based evaluation of input scan points process 800 (or “evaluation process 800”) according to various aspects and embodiments of the present disclosure. The evaluation process 800 shown in FIG. 8 illustrates a simple 2D evaluation of scan points against a fully dense 2D voxel SDF that can be performed by the computing device 102 in many examples. The computing device 102 can input collected scan points (xₚ, yₚ) directly into an analytic equation of a target geometry, as shown in FIG. 8.

As mentioned previously, a data scalable and rapid approach the computing device 102 can implement to evaluate point clouds is critical for it to be compatible with a production environment, ideally enabling layer-wise evaluation. Since SDFs are pure functions, where identical function inputs ensure identical outputs, SDFs can be evaluated with parallel computation in some cases. The computing device 102 can implement a GPU-accelerated SDF approach in many examples and use a manufacturing optimized codebase to evaluate collected scan points as described herein.

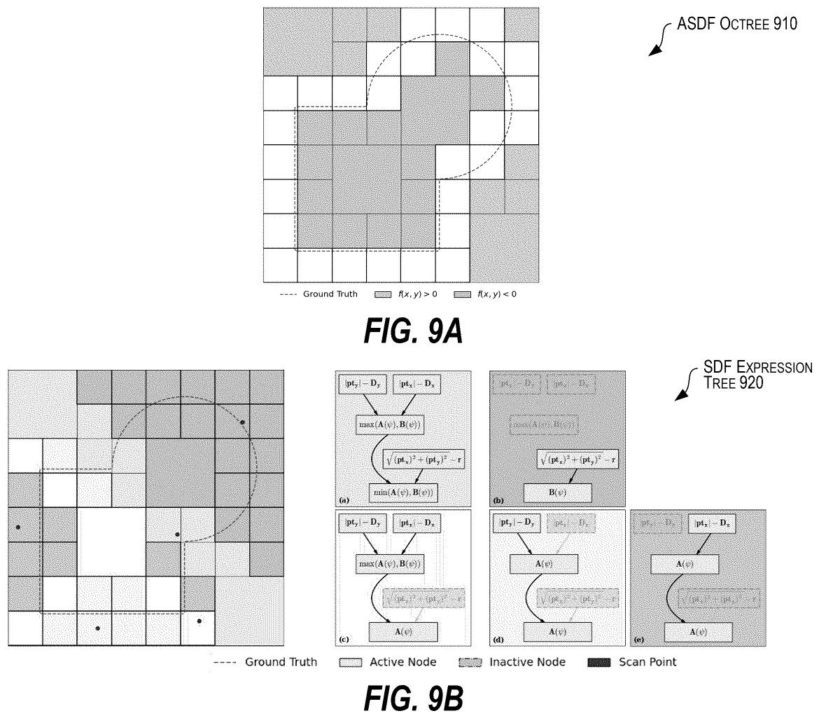

The underlying SDF method implemented by the computing device 102 is organized as an Adaptively Sampled Distance Function (ASDF) in which the distance function is volumetrically discretized using an ASDF octree 910 in many cases, seen in FIG. 9A. FIG. 9A illustrates an example ASDF octree 910 according to various aspects and embodiments of the present disclosure. The ASDF octree includes leaf nodes that each have an SDF expression tree 920, seen in FIG. 9B. FIG. 9B illustrates an example SDF expression tree 920 according to various aspects and embodiments of the present disclosure. The computing device 102 can pair each scan point with a pruned expression tree, relevant to its local SDF, to form an instruction set for a GPU interpreter in many examples. Each leaf node of the ASDF octree 910 shown in FIG. 9A can store an algebraic expression tree (e.g., tree within a tree) of the SDF in many cases. Because the octree 910 can store the SDF expression, this approach is completely analytic, volume filling, and can be evaluated at arbitrary resolution when implemented by the computing device 102.

To make the evaluation of scan points faster and decrease memory cost for storing the target geometry, in many cases the computing device 102 can simplify the SDF expression tree stored within each octree leaf node. Each leaf node in the octree can be started by the embodiments with a full expression tree of the closed-form SDF, as shown in FIG. 9B. As the computing device 102 recursively iterates and refines the tree to find an isosurface of a geometry, it can also record the traversed expression nodes in many examples. Nodes that are not traversed (i.e., not part of the regional evaluation) can be set as inactive in the expression tree and removed by the computing device 102 in many examples. With every leaf node's refined expression tree, instruction sets can be created by the computing device 102 in many cases for an interpreter running on a GPU.

Expression trees can be pruned and converted into a set of instructions in some examples. Pruning of an expression tree according to the traversed nodes as described above is optional (e.g., an unoptimized SDF expression tree still forms a valid implicit target geometry) but the computing device 102 can complete such pruning to facilitate faster computation in some cases.

To evaluate a 3D scan, the computing device 102 can first pair scan points with their locally relevant instruction set. The computing device 102 can achieve this by sorting points into the leaf-nodes of the ASDF octree 910 and pairing them with the likewise stored locally relevant instruction set.

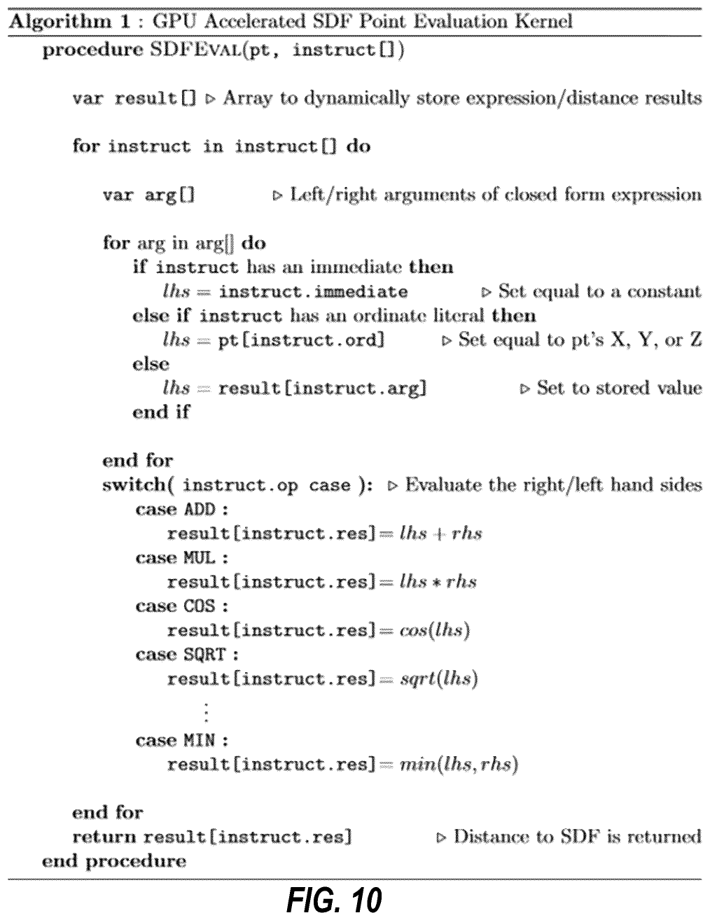

With points and instructions coupled, the computing device 102 can create a GPU thread for each scan point in many examples using Algorithm 1 described herein and illustrated in FIG. 10. FIG. 10 illustrates an example GPU accelerated SDF point evaluation kernel (or “Algorithm 1”) according to various aspects and embodiments of the present disclosure. The computing device 102 can implement Algorithm 1 in many cases to create a plurality of GPU threads such that each GPU thread has an instance of an interpreter that accepts a locally relevant instruction list and the point. The point the computing device 102 passes to the interpreter can be an array including three floating point values for X, Y, and Z positional scan data in the example shown. An instruction can perform a single operation in this example, containing a mathematical function case/code, argument references for the operation, and a location to store results.

Input arguments to the mathematical operation exist as one of three types in the example shown: 1) an immediate, 2) an ordinate literal, or 3) a result from a previous operation. An immediate specifies a supplied constant stored within the instruction as an argument. The ordinate literal flag indicates which scan point field (X, Y, or Z) to insert as an argument. If no other argument condition is applied, then the instruction includes an index to a previous operation result stored within the kernel (e.g., in the kernel's result array).

With all input arguments specified, the computing device 102 can evaluate the operation and store the result for future operations in many examples. To accommodate this, the instruction in many cases can include a 1-byte index to the result array within the kernel Algorithm 1. The computing device 102 can iterate the kernel Algorithm 1 through the array of supplied instructions, and once complete, output a scan point's signed distance in many examples.

Referring now to FIG. 1, the memory 114 can store other executable-code components for execution by the processor 112. For example, an operating system can be stored in the memory 114 for execution by the processor 112. Where any component discussed herein is implemented in the form of software, any one of a number of programming languages can be employed such as, for example, C, C++, C#, Objective C, JAVA®, JAVASCRIPT®, Perl, PHP, VISUAL BASIC®, PYTHON®, RUBY, FLASH®, or other programming languages.

As discussed above, the memory 114 can store software for execution by the processor 112. In this respect, the terms “executable” or “for execution” refer to software forms that can ultimately be run or executed by the processor 112, whether in source, object, machine, or other form. Examples of executable programs include, for instance, a compiled program that can be translated into a machine code format and loaded into a random access portion of the memory 114 and executed by the processor 112, source code that can be expressed in an object code format and loaded into a random access portion of the memory 114 and executed by the processor 112, source code that can be interpreted by another executable program to generate instructions in a random access portion of the memory 114 and executed by the processor 112, or other executable programs or code. An executable program can be stored in any portion or component of the memory 114. The memory 114 can be embodied as, for example, a random access memory (RAM), read-only memory (ROM), magnetic or other hard disk drive, solid-state, semiconductor, universal serial bus (USB) flash drive, memory card, optical disc (e.g., compact disc (CD) or digital versatile disc (DVD)), floppy disk, magnetic tape, or other types of memory devices.

In various embodiments, the memory 114 can include both volatile and nonvolatile memory and data storage components. Volatile components are those that do not retain data values upon loss of power. Nonvolatile components are those that retain data upon a loss of power. Thus, the memory 114 can include, for example, a RAM, ROM, magnetic or other hard disk drive, solid-state, semiconductor, or similar drive, USB flash drive, memory card accessed via a memory card reader, floppy disk accessed via an associated floppy disk drive, optical disc accessed via an optical disc drive, magnetic tape accessed via an appropriate tape drive, and/or other memory component, or any combination thereof. In addition, the RAM can include, for example, a static random-access memory (SRAM), dynamic random-access memory (DRAM), or magnetic random-access memory (MRAM), and/or other similar memory device. The ROM can include, for example, a programmable read-only memory (PROM), erasable programmable read-only memory (EPROM), electrically erasable programmable read-only memory (EEPROM), or other similar memory devices.

Also, the processor 112 may represent multiple processors 112 and/or multiple processor cores and the memory 114 may represent multiple memories 114 that operate in parallel processing circuits, respectively. In such a case, the local interface 116 may be an appropriate network that facilitates communication between any two of the multiple processors 112, between any processor 112 and any of the memories 114, or between any two of the memories 114, etc. The local interface 116 may include additional systems designed to coordinate this communication, including, for example, performing load balancing. The processor 112 may be of electrical or of some other available construction.

Any or all of the geometric signature formation module 120, the geometric error evaluation module 122, the geometric error communication and correction module 124, and the communications stack 126 can be embodied, at least in part, through software or program instructions. The program instructions may be embodied in the form of source code that comprises human-readable statements written in a programming language or machine code that comprises numerical instructions recognizable by a suitable execution system such as a processor 112 in a computer system or other system. The machine code may be converted from the source code, etc. If embodied in hardware, each block may represent a circuit or a number of interconnected circuits to implement the specified logical function(s).

Further, any logic or application described herein, including the geometric signature formation module 120, the geometric error evaluation module 122, the geometric error communication and correction module 124, and the communications stack 126, may be implemented and structured in a variety of ways. For example, one or more applications described may be implemented as modules or components of a single application. Further, one or more applications described herein may be executed in shared or separate computing devices or a combination thereof. For example, a plurality of the applications described herein may execute in the same computing device, or in multiple computing devices in the same the computing environment.

As discussed above, the geometric signature formation module 120, the geometric error evaluation module 122, the geometric error communication and correction module 124, and the communications stack 126 can each be embodied, at least in part, by software or executable-code components for execution by general purpose hardware. Alternatively, the same can be embodied in dedicated hardware or a combination of software, general, specific, and/or dedicated purpose hardware. If embodied in such hardware, each can be implemented as a circuit or state machine, for example, that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components.

Referring now to FIGS. 2 and 5, the flowchart or process diagram shown in each of FIGS. 2 and 5 is representative of certain processes, functionality, and operations of the embodiments discussed herein. Each block can represent one or a combination of steps or executions in a process. Alternatively, or additionally, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as the processor 112. The machine code can be converted from the source code. Further, each block can represent, or be connected with, a circuit or a number of interconnected circuits to implement a certain logical function or process step.

Although the flowchart or process diagram shown in each of FIGS. 2 and 5 illustrates a specific order, it is understood that the order can differ from that which is depicted. For example, an order of execution of two or more blocks can be scrambled relative to the order shown. Also, two or more blocks shown in succession can be executed concurrently or with partial concurrence. Further, in some embodiments, one or more of the blocks can be skipped or omitted. In addition, any number of counters, state variables, warning semaphores, or messages might be added to the logical flow described herein, for purposes of enhanced utility, accounting, performance measurement, or providing troubleshooting aids. Such variations, as understood for implementing the process consistent with the concepts described herein, are within the scope of the embodiments.

Also, any logic or application described herein, including the geometric signature formation module 120, the geometric error evaluation module 122, the geometric error communication and correction module 124, and the communications stack 126 can be embodied, at least in part, by software or executable-code components and/or stored in any tangible or non-transitory computer-readable medium or device for execution by an instruction execution system such as a general-purpose processor. In this sense, the logic can be embodied as, for example, software or executable-code components that can be fetched from the computer-readable medium and executed by the instruction execution system. Thus, the instruction execution system can be directed by execution of the instructions to perform certain processes such as those illustrated in FIGS. 2 and 5. In the context of the present disclosure, a non-transitory computer-readable medium can be any tangible medium that can contain, store, or maintain any logic, application, software, or executable-code component described herein for use by or in connection with an instruction execution system.

The computer-readable medium can include any physical media such as, for example, magnetic, optical, or semiconductor media. More specific examples of suitable computer-readable media include, but are not limited to, magnetic tapes, magnetic floppy diskettes, magnetic hard drives, memory cards, solid-state drives, USB flash drives, or optical discs. Also, the computer-readable medium can include a RAM including, for example, an SRAM, DRAM, or MRAM. In addition, the computer-readable medium can include a ROM, a PROM, an EPROM, an EEPROM, or other similar memory device.

Disjunctive language, such as the phrase “at least one of X, Y, or Z,” unless specifically stated otherwise, is to be understood with the context as used in general to present that an item, term, or the like, can be either X, Y, or Z, or any combination thereof (e.g., X, Y, and/or Z). Thus, such disjunctive language is not generally intended to, and should not, imply that certain embodiments require at least one of X, at least one of Y, or at least one of Z to be each present. As referenced herein in the context of quantity, the terms “a” or “an” are intended to mean “at least one” and are not intended to imply “one and only one.”

As referred to herein, the terms “include,” “includes,” and “including” are each intended to be inclusive in a manner similar to the term “comprising.” As referenced herein, the terms “or” and “and/or” are generally intended to be inclusive, that is (i.e.), “A or B” or “A and/or B” are each intended to mean “A or B or both.” As referred to herein, the terms “first,” “second,” “third,” and so on, can be used interchangeably to distinguish one component or entity from another and are not intended to signify location, functionality, or importance of the individual components or entities. As referenced herein, the terms “couple,” “couples,” “coupled,” and/or “coupling” refer to chemical coupling (e.g., chemical bonding), communicative coupling, electrical and/or electromagnetic coupling (e.g., capacitive coupling, inductive coupling, direct and/or connected coupling), mechanical coupling, operative coupling, optical coupling, and/or physical coupling.

It should be emphasized that the above-described embodiments of the present disclosure are merely possible examples of implementations set forth for a clear understanding of the principles of the disclosure. Many variations and modifications can be made to the above-described embodiment(s) without departing substantially from the spirit and principles of the disclosure. All such modifications and variations are intended to be included herein within the scope of this disclosure and protected by the following claims.

Therefore, at least the following is claimed:

1. A manufacturing workcell, comprising:
a plurality of in-situ sensors individually configured to capture discrete geometric signature data indicative of at least one layer of a printing part positioned in the manufacturing workcell during a manufacturing process; and
a computing device coupled to the plurality of in-situ sensors, the computing device comprising:
a memory device to store computer-readable instructions thereon; and
at least one processing device configured through execution of the computer-readable instructions to perform an in-situ evaluation of geometric error of the printing part at the manufacturing workcell during the manufacturing process based at least in part on the discrete geometric signature data.

2. The manufacturing workcell of claim 1, wherein, to perform the in-situ evaluation of geometric error of the printing part, the at least one processing device is further configured through execution of the computer-readable instructions to:
perform a geometric comparison of the at least one layer of the printing part against an as-designed model corresponding to the printing part during the manufacturing process.

3. The manufacturing workcell of claim 1, wherein, to perform the in-situ evaluation of geometric error of the printing part, the at least one processing device is further configured through execution of the computer-readable instructions to:
perform a geometric comparison of the at least one layer of the printing part against an as-designed model corresponding to the printing part based on an adaptively sampled distance function during the manufacturing process.

4. The manufacturing workcell of claim 1, wherein the plurality of in-situ sensors comprises individual in-situ stereo structured light scanning systems coupled to and arranged about the manufacturing workcell.

5. The manufacturing workcell of claim 1, wherein:
the at least one processing device is further configured through execution of the computer-readable instructions to operate individual in-situ sensors among the plurality of in-situ sensors to separately capture the discrete geometrical signature data; and
the discrete geometrical signature data comprises at least one of three-dimensional scan data, thermal data, visual data, acoustic data, or image data indicative of the at least one layer of the printing part during the manufacturing process.

6. The manufacturing workcell of claim 1, wherein the at least one processing device is further configured through execution of the computer-readable instructions to:
perform a data fusion process to obtain comprehensive geometric signature data indicative of the at least one layer of the printing part based at least in part on the discrete geometric signature data captured by individual in-situ sensors among the plurality of in-situ sensors.

7. The manufacturing workcell of claim 1, wherein the at least one processing device is further configured through execution of the computer-readable instructions to:
perform a global registration process to determine a homogenous transformation between reference frames of individual in-situ sensors among the plurality of in-situ sensors and a reference frame of a machine coordinate system corresponding to at least one of the manufacturing workcell or a manufacturing system in which the manufacturing process is performed.

8. The manufacturing workcell of claim 7, wherein, to perform the global registration process, the at least one processing device is further configured through execution of the computer-readable instructions to:
operate each of the individual in-situ sensors to separately capture three-dimensional scans of a physical three-dimensional marker aligned to the machine coordinate system.

9. The manufacturing workcell of claim 8, wherein, to perform the global registration process, the at least one processing device is further configured through execution of the computer-readable instructions to:
obtain respective point clouds generated in the reference frames of the individual in-situ sensors for the three-dimensional scans of the physical three-dimensional marker aligned to the machine coordinate system.

10. The manufacturing workcell of claim 9, wherein, to perform the global registration process, the at least one processing device is further configured through execution of the computer-readable instructions to:
transform the reference frames of the individual in-situ sensors to the reference frame of the machine coordinate system by fitting the respective point clouds to a ground truth marker point cloud aligned with the machine coordinate system, the ground truth marker point cloud being generated based at least in part on an as-designed model corresponding to the printing part and the physical three-dimensional marker.

11. The manufacturing workcell of claim 10, wherein, to perform the global registration process, the at least one processing device is further configured through execution of the computer-readable instructions to:
implement a random sample consensus process for global registration of the respective point clouds to the ground truth marker point cloud aligned with the machine coordinate system; and
implement a point-to-plane iterative-closest-point process for final registration of the respective point clouds to the ground truth marker point cloud aligned with the machine coordinate system.

12. The manufacturing workcell of claim 6, wherein the at least one processing device is further configured through execution of the computer-readable instructions to:
modify at least one of the printing part or the manufacturing process based at least in part on one or more of the comprehensive geometric signature data or the geometric error.

13. The manufacturing workcell of claim 6, wherein the at least one processing device is further configured through execution of the computer-readable instructions to:
provide at least one of the comprehensive geometric signature data or the geometric error to a second computing device to modify at least one of the printing part or the manufacturing process based at least in part on one or more of the comprehensive geometric signature data or the geometric error.

14. The manufacturing workcell of claim 6, wherein the at least one processing device is further configured through execution of the computer-readable instructions to:
format at least one of the discrete geometric signature data, the comprehensive geometric signature data, the geometric error, or an as-designed model corresponding to the printing part for visual rendering in at least one of an augmented reality environment or a virtual reality environment.

15. The manufacturing workcell of claim 6, wherein the at least one processing device is further configured through execution of the computer-readable instructions to:
render visualizations of at least one of the discrete geometric signature data, the comprehensive geometric signature data, the geometric error, or an as-designed model corresponding to the printing part in at least one of an augmented reality environment or a virtual reality environment.

16. A method of in-situ geometric monitoring for a manufacturing process, the method comprising:
operating, by at least one processor, a plurality of in-situ sensors within a manufacturing workcell to capture discrete geometric signature data indicative of at least one layer of a printing part positioned in the manufacturing workcell during the manufacturing process; and
performing, by the at least one processor, an in-situ evaluation of geometric error of the printing part at the manufacturing workcell during the manufacturing process based at least in part on the discrete geometric signature data.

17. The method of claim 16, wherein performing the in-situ evaluation of geometric error of the printing part comprises:
performing, by the at least one processor, a geometric comparison of the at least one layer of the printing part against an as-designed model corresponding to the printing part during the manufacturing process.

18. The method of claim 16, wherein operating the plurality of in-situ sensors comprises:
operating, by the at least one processor, individual in-situ sensors coupled to and arranged about the manufacturing workcell to separately capture the discrete geometrical signature data, the discrete geometrical signature data comprising at least one of three-dimensional scan data, thermal data, visual data, acoustic data, or image data indicative of the at least one layer of the printing part during the manufacturing process.

19. The method of claim 16, further comprising:
performing, by the at least one processor, a data fusion process to obtain comprehensive geometric signature data indicative of the at least one layer of the printing part based at least in part on the discrete geometric signature data captured by individual in-situ sensors in the plurality of in-situ sensors.

20. The method of claim 16, further comprising:
performing, by the at least one processor, a global registration process to determine a homogenous transformation between reference frames of individual in-situ sensors in the plurality of in-situ sensors and a reference frame of a machine coordinate system corresponding to at least one of the manufacturing workcell or a manufacturing system in which the manufacturing process is performed.
